(19) United States
(12) Patent Application Publication
(10) Pub. No.: US 2007/0008095 A1
(43) Pub. Date: Jan. 11, 2007

(54) Intelligent brake light system

(76) Inventors: H.S. Meade Gwinn, Manassas, VA (US); Mehdi Ahmadian, Blacksburg, VA (US)

Correspondence Address: KRAMER & AMADO, P.C., 1725 DUKE STREET, SUITE 240, ALEXANDRIA, VA, 22314, US

(21) Appl. No.: 11/213,709

(22) Filed: Aug. 30, 2005

Related U.S. Application Data
(60) Provisional application No. 60/688,719, filed on Jun. 9, 2005.

(51) Int. Cl. B60Q 1/40

(52) U.S. Cl. 340/476

(57) ABSTRACT

A brake light system includes a brake light having at least two brake indicating modes. The brake light system also includes a controller for monitoring a braking condition and a driving condition. The controller determines which one of the brake indicating modes the brake light displays based on the braking condition and the driving condition.

### BACKGROUND

A great majority of automobile accidents involve rear end collisions. A driver misjudging the rate at which a lead vehicle is slowing is the major cause of rear end collisions. A great number of rear end collisions may be avoided by appropriately warning other drivers of the vehicles level of braking. Several brake light systems have been proposed to warn other drivers and reduce these collisions. One such brake light.system increases the intensity of the brake light based upon how hard the driver applies the brakes. However, these systems are not adjustable and do not vary light intensity based on other factors. Thus, the brake light system may give a false indicator. It may indicate too low a level of braking when other conditions call for an indication of a higher level of braking and vice versa. This misinformation leads other drivers to eventually ignore these systems because of the misinformation they provide. What is needed is a brake light system for appropriately warning other driving of the level of breaking while considering other factors.

### SUMMARY

According to an embodiment, a brake light system includes a brake light having at least two brake indicating modes. The brake light system also includes a controller for monitoring a braking condition and a driving condition. The controller determines which one of the brake indicating modes the brake light displays based on the braking condition and the driving condition.

### BRIEF DESCRIPTION OF THE DRAWINGS

Examples of the invention are illustrated, without limitation, in the accompanying figures in which like numeral references refer to like elements, and wherein:

FIG. 1 shows a simplified diagram of a brake light system in accordance with an embodiment;

FIG. 2 shows a simplified diagram of a brake light in accordance with an embodiment;

FIG. 3 shows a simplified diagram of brake light modes in accordance with an embodiment;

FIG. 4 shows a flow diagram of a method for operating a brake light system in accordance with an embodiment; and

FIG. 5 shows a flow diagram of a method for operating a brake light system in accordance with another embodiment.

### DETAILED DESCRIPTION

For simplicity and illustrative purposes, the principles are shown by way of examples of systems and methods described. In the following description, numerous specific details are set forth in order to provide a thorough understanding of the examples. It will be apparent however, to one of ordinary skill in the art, that the examples may be practiced without limitation to these specific details. In other instances, well known methods and structures are not described in detail so as not to unnecessarily obscure understanding of the examples.

Throughout the present disclosure, reference is made to a braking condition. The braking condition may be any condition related to the amount of braking applied to and the response thereof a vehicle. For instance, brake line pressure or the amount of force used on the braking pedal may be braking conditions. Additionally, other factors affecting braking distance may be braking conditions. For instance, the incline or decline of the vehicle may affect braking distance and are therefore considered braking conditions. Other examples of braking conditions include driving speed, deceleration, steering angle, and wheel lock.

Reference is also made to a driving condition. The driving condition may be any condition external to a vehicle which may affect the amount of warning needed by other drivers. For instance, heavy traffic conditions may lead to stop and go traffic forcing drivers to apply brakes often hastily. This creates hazard conditions and is considered a driving condition. Another example may include weather conditions. For instance, rainy weather may reduce the overall braking distance of vehicles. Even moderate braking of a vehicle ahead of a driver may force the driver to brake hastily and skid on a wet road. Therefore, a driver following another vehicle will need to know about even moderate breaking as soon as feasible. Other examples of driving conditions may include highway driving, city driving, heavy traffic, low traffic, and weather.

In an example, a brake light system includes a brake light for displaying multiple modes or levels of braking to another driver. The brake light system includes a controller for controlling the braking mode displayed. The controller monitors a braking condition and a driving condition to determine which braking mode to display. For instance, a moderate level of braking may be initiated by a driver in inclement weather. The controller then determines which brake mode to display based on these conditions and activates the appropriate braking mode.

In another example, the controller uses sensors in the vehicle or in the brake light system itself to monitor braking and driving conditions. The braking conditions may include driving speed, deceleration, steering angle, wheel lock, incline, and decline. These conditions may affect braking distance. The driving conditions may include highway driving, city driving, heavy traffic, low traffic, and weather conditions. These conditions may affect the amount of warning needed by another driver behind the vehicle. In yet another example, driving conditions may be transmitted to the brake light system from a remote source. For instance, traffic or weather conditions may be transmitted to the brake light system from a third party using any type of wireless system or network. Cellular tower, satellites, or radio transmitters may send driving condition information to the brake light system.

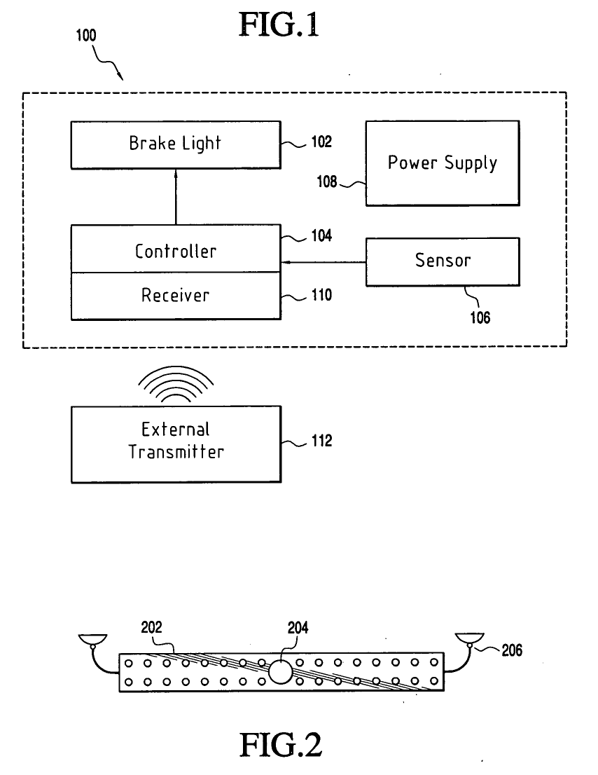

With reference first to FIG. 1, there is shown a brake light system 100 including a brake light 102, a controller 104, and a sensor 106. The brake light system 100 may also include a power supply 108. The controller 104 may include a receiver 110. Also shown in FIG. 1 is an external transmitter 112. The brake light 102 displays one of several modes or levels of braking to another driver. The controller 104 sends a signal or directly powers the brake light 102 for displaying a braking mode to another driver. The controller 104 receives information from sensors, such as sensor 106, regarding braking and driving conditions. The controller 104 evaluates these conditions to determine which braking mode the brake light 102 displays.

The sensor 106 may be any type for detecting any one of the braking or driving conditions. For instance, the sensor 106 may be a pressure transducer to detecting brake line fluid pressure thus determining how hard a driver of the vehicle is braking. In another example, the sensor 106 may be an inertia sensor or accelerometer used to determine the magnitude of deceleration. The sensor 106 may be a position sensor used to determine the position of the brake pedal or accelerator pedal. The sensor 106 may also be a tilt sensor used to determine if the vehicle is on an incline or decline when braking occurs. In yet another example, the sensor 106 may be configured to detect a driving condition of a road such as wetness. The sensor 106 may be located within a container housing the brake light system 100. Alternatively, the sensor 106 may be part of the vehicle electrical system which connects to the brake light system 100 through a wiring harness. It should be understood that any type of sensor for detecting any braking or driving condition may be used. Additionally, any number of sensors may be used to input braking and driving information to the controller 104.

The brake light system 100 may include a power supply 108 for powering the controller 104, sensor 106, and brake light 102. The power supply 108 may be a battery located in a container housing the brake light system 100. In this example, the entire brake light system 100 may be self-contained in a single unit. In another example, the power may be supplied by the vehicle's battery or other power system.

The controller 104 of the brake light system 100 may include a receiver 110. The receiver 110 may wirelessly receive information from the external transmitter 112. The external transmitter 112 may be used to collect driving conditions at a particular location and transmit these driving conditions to the controller 104. For instance, the external transmitter 112 may be positioned at various locations in a city or near a highway. In this case, the external transmitter 112 would transmit a signal representing a driving condition to the controller 104. If the external transmitter 112 is located within a city, the signal may notify the controller 104 that the driving condition is city driving. The controller 104 then makes adjustments to the braking mode displayed by the brake light 102. The external transmitter 112 may also include a sensor for detecting driving conditions such as heavy or light traffic and transmit this information to the controller 104.

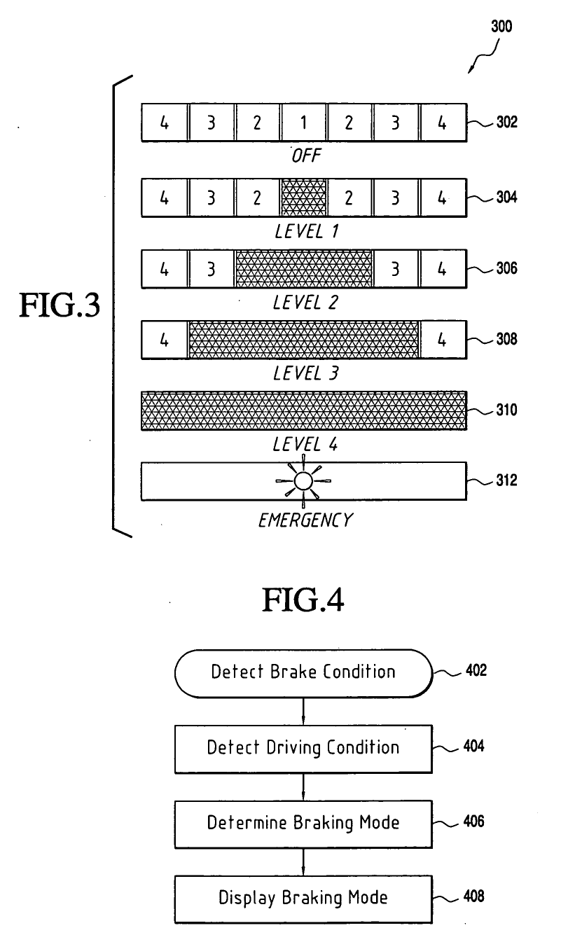

With reference now to FIG. 2, there is shown a simplified diagram of a brake light housing assembly 200. The brake light housing assembly 200 includes a brake light configured as a plurality of light emitting diodes 202 arranged in one or more rows, a strobe light 204, and a mounting system 206. The light emitting diodes 202 may be turned on selectively in a progressive pattern to indicate the various braking modes discussed above. A particular progressive pattern is discussed below with reference to FIG. 3. Additionally, the light emitting diodes 202 may vary in color or intensity to firther clarify or distinguish the various braking modes. The strobe light 204 may be included in the brake light housing assembly 200 to indicate an emergency condition such as wheel lock or skidding.

The mounting system 206 may be used to mount the brake light housing assembly 200 such that it is viewable from the rear of a vehicle. In one example, the mounting system 206 includes brackets and suction cups for removable mounting of the brake light housing assembly 200 to the rear window of the vehicle. In another example, the mounting system 206 may include a magnetic strip for mounting the brake light housing assembly 200 to the vehicle. It should be understood that mounting the brake light housing assembly 200 to the vehicle may be accomplished in a variety of manners. Therefore, the mounting system 206 should not be limited to the examples discussed above.

FIG. 3 shows an example of the various braking modes displayed by the brake light housing assembly 200 of FIG. 2. The light emitting diodes 202 are selectively activated in particular zones to display the various braking modes. In the off mode 302, none of the light emitting diodes 202 are activated. The off mode 302 illustrates a series of zones labeled zone 1, zone 2, zone 3, and zone 4. The brake light displays a level I mode 304 when the light emitting diodes 202 in zone I are activated. The level 1 mode 304 represents a relatively low level of braking. The brake light displays a level 2 mode 306 when the light emitting diodes 202 in zones 1 and 2 are activated. The level 2 mode 306 represents a higher level ofbraking than the level I mode 304. The brake light displays a level 3 mode 308 when the light emitting diodes 202 in zones 1, 2, and 3 are activated. The level 3 mode 308 represents a higher level of braking than the level 2 mode 306. The brake light displays a level 4 mode 310 when the light emitting diodes 202 in zones 1, 2, 3, and 4 are activated. The level 4 mode 310 represents the highest level of braking other than an emergency condition. The brake light displays an emergency condition 312 when the strobe light 204 flashes or the light emitting diodes 202 in zones 1, 2, 3, and 4 flash.

FIG. 4 shows a flow diagram of a method 400 for operating a brake light system. The following description of the method 400 is made with reference to the system 100 illustrated in FIG. 1, and thus makes reference to the elements cited therein. The following description of the method 400 is one manner in which the system 100 may be implemented. In this respect, it is to be understood that the following description of the method 400 is but one manner of a variety of different manners in which such a system may be implemented.

In the method 400, the controller 104 detects a braking condition at step 402. This may be accomplished by monitoring any one of a number of sensors. For instance, the controller 104 may monitor a brake pedal sensor or a brake line pressure sensor to determine that the brakes have been activated. Additionally, the controller 104 may monitor an inertia sensor for detecting deceleration. In this example, the brake light 102 may be activated before a driver uses the brakes of the vehicle. In another example, the controller 104 may detect more than one braking condition. For instance, the controller 104 may detect brake line pressure increase, vehicle deceleration, and wheel lock. The controller 104 then detects the driving condition at step 404. This may be accomplished by polling the sensor 106 or determining if a transmission has been received from the external transmitter 112.

Once the controller 104 knows both the braking condition and the driving condition, the controller 104 then determines which of the braking modes to display at step 406. The controller 104 may make this determination according to a variety of methods. For instance, the controller 104 may use a look-up table listing the various braking conditions and driving conditions to determine which braking mode to display. In another example, the controller 104 may use predetermined threshold levels for each braking condition based upon a predefined arrangement. In that case, the controller 104 may adjust the threshold levels up or down depending on the particular driving condition. In yet another example, the controller 104 may use a series of logic circuits arranged to receive as inputs both braking conditions and driving conditions. In this case, the logic circuits may output a signal for driving the brake light 102 to display the appropriate braking mode. The controller 104 then sends a signal to the braking light 102 to display the appropriate braking mode at step 408.

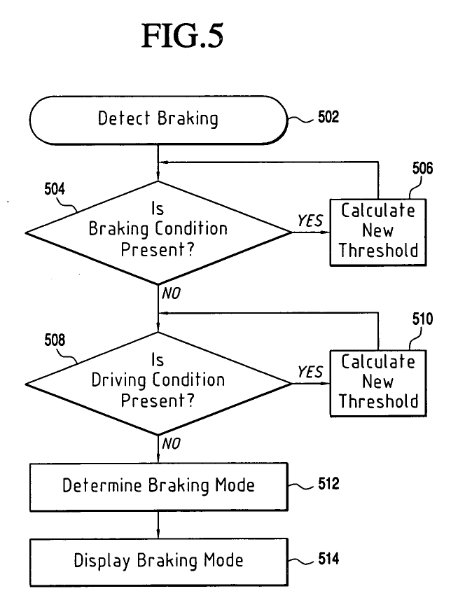

FIG. 5 shows a flow diagram of a method 500 for operating a brake light system. The following description of the method 500 is made with reference to the system 100 illustrated in FIG. 1, and thus makes reference to the elements cited therein. The following description of the method 500 is one manner in which the system 100 may be implemented. In this respect, it is to be understood that the following description of the method 500 is but one manner of a variety of different manners in which such a system may be implemented.

In the method 500, the controller 104 is configured to activate the brake light 102 according to a set of predefined thresholds depending upon various braking conditions. First, the controller 104 detects braking at step 502. This may be accomplished by monitoring a brake pedal sensor or brake line pressure. Alternatively, this may be accomplished by monitoring an inertia sensor or accelerometer. Once braking is detected, the controller 104 polls sensors to determine if any other braking condition is present at step 504. If another braking condition is present, the controller 104 calculates a new threshold based upon the braking condition at step 506. Control then returns to step 504 wherein the controller 104 polls sensors to determine if any other braking condition is present. This loop may continue until all possible braking conditions have been considered.

Some braking conditions may lower the predetermined threshold while other braking conditions may increase the predetermined threshold. For instance, a very high brake line pressure may lower the predetermined threshold causing the brake light 102 to indicate a higher level of braking than normal. In another instance, a very low deceleration rate may increase the predetermined threshold causing the brake light 102 to indicate a lower level of braking than normal. In addition, a combination of braking conditions may work together to drastically lower the predetermined threshold. For instance, a very high brake line pressure, very high deceleration rate, and wheel lock may reduce the threshold such that the emergency condition (strobe light or flashing light emitting diodes) is activated.

Once all braking conditions have been evaluated, the controller 104 then polls sensors to determine which driving condition is present at step 508. If a driving condition is indicated, the controller 104 calculates a new threshold at step 510. Control then returns to step 508 wherein the controller 104 polls sensors to determine if any other driving condition is present. This loop may continue until all possible driving conditions have been considered.

Some driving conditions may lower the predetermined threshold while other driving conditions may increase the predetermined threshold. For instance, a heavy traffic condition may lower the predetermined threshold causing the brake light 102 to indicate a higher level of braking than normal. In another instance, a low traffic condition may increase the predetermined threshold causing the brake light 102 to indicate a lower level of braking than normal. In addition, a combination of braking conditions and driving conditions may work together to drastically lower the predetermined threshold. For instance, a very high brake line pressure, very high deceleration rate, and wheel lock along with a heavy traffic driving condition may reduce the threshold such that the emergency condition (strobe light or flashing light emitting diodes) is activated.

Once all driving conditions have been considered, the controller 104 then determines which braking mode the brake light 102 should display based upon the newly calculated threshold at step 512. This may be accomplished by calculating a braking value based upon deceleration, brake line pressure, and/or break pedal pressure. This braking value is then compared to the newly calculated threshold value. In this example, there may be five threshold values; one value for each of the four braking modes and one value for the emergency mode. If the braking value exceeds the first threshold value, the first braking mode is displayed. Each threshold value is evaluated until the proper braking mode is determined. The controller 104 then sends a signal to the braking light 102 to display the appropriate braking mode at step 514.

What has been described and illustrated herein are examples of the systems and methods described herein along with some of their variations. The terms, descriptions and figures used herein are set forth by way of illustration only and are not meant as limitations. Those skilled in the art will recognize that many variations are possible within the spirit and scope of these examples, which intended to be defined by the following claims and their equivalents in which all terms are meant in their broadest reasonable sense unless otherwise indicated.

What is claimed is:

1. A brake light system comprising:
a brake light having at least two brake indicating modes;
a controller for monitoring a braking condition and a driving condition, wherein the controller determines one of the at least two brake indicating modes the brake light displays based on the braking condition and the driving condition.

2. The brake light system of claim 1 wherein the brake light further comprising a plurality of light emitting diodes arranged in one or more rows and wherein one of the at least two brake indicating modes includes activating a predetermined number of the plurality of light emitting diodes and wherein another one of the at least two brake indicating modes includes activating a second predetermined number of the plurality of light emitting diodes.

3. The brake light system of claim 2, further comprising a strobe light for indicating an emergency braking condition determined by the controller.

4. The brake light system of claim 2, wherein the plurality of light emitting diodes comprise at least two colors.

5. The brake light system of claim 1 wherein the braking condition includes at least one of driving speed, deceleration, steering angle, wheel lock, incline, and decline and further comprising at least one sensor for detecting the braking condition.

6. The brake light system of claim 1 wherein the driving condition includes at least one of highway driving, city driving, heavy traffic, low traffic, and a weather condition and further comprising at least one sensor for detecting the driving condition.

7. The brake light system of claim 6 wherein the braking condition includes at least one of driving speed, deceleration, steering angle, wheel lock, incline, and decline and further comprising at least one sensor for detecting the braking condition.

8. The brake light system of claim 6 further comprising a receiver for receiving a signal from a remote source, the signal indicating the driving condition.

9. The brake light system of claim 1 further comprising:
a sensor for detecting the driving condition;
a power source for operating the controller, the brake light, and the sensor; and
a housing for containing the brake light, the controller, the sensor, and the power source.

10. A method for operating a brake light having a plurality of indicating modes, the method comprising:
detecting a braking condition;
detecting a driving condition;
determining which of the plurality of indicating modes the brake light should indicate based upon the braking condition and the driving condition.

11. The method of claim 10 wherein detecting the braking condition further comprises detecting at least one of driving speed, deceleration, steering angle, wheel lock, incline, and decline.

12. The method of claim 10 wherein detecting the driving condition further comprises detecting at least one of highway driving, city driving, heavy traffic, low traffic, and a weather condition.

13. The method of claim 12 wherein detecting the braking condition further comprises detecting at least one of driving speed, deceleration, steering angle, wheel lock, incline, and decline.

14. The method of claim 12, further comprising receiving a signal from a remote source indicating the driving condition.

15. The method of claim 10, further comprising displaying at least one of the plurality of indicating modes using a series of light emitting diodes arranged in a row.

16. The method of claim 15, further comprising displaying at least one of the plurality of indicating modes by flashing the series of light emitting diodes.

17. The method of claim 15, further comprising displaying at least one of the plurality of indicating modes using a strobe light.

18. A brake light system comprising:
means for indicating a braking mode;
means for monitoring a braking condition and a driving condition; and
means for determining the braking mode to indicate based upon the braking condition and the driving condition.

19. The brake light system of claim 18, further comprising means for receiving the driving condition from a remote source.

20. The brake light system of claim 18, further comprising means for indicating an emergency braking condition.
